(19) United States
(12) Patent Application Publication
(10) Pub. No.: US 2015/0067598 A1
(43) Pub. Date: Mar. 5, 2015

(54) SYSTEM AND METHOD FOR DYNAMIC VISUALIZATION OF POI ATTRIBUTES AND METHOD FOR REFRESHING POI ATTRIBUTES

(71) Applicant: Electronics and Telecommunications Research Institute, Daejeon (KR)

(72) Inventors: Jaejun YOO, Daejeon (KR); Suwook HA, Daejeon (KR)

(73) Assignee: Electronics and Telecommunications Research Institute, Daejoen (KR)

(21) Appl. No.: 14/183,787

(22) Filed: Feb. 19, 2014

(30) Foreign Application Priority Data
Sep. 4, 2013 (KR) 10-2013-0106101

(51) Int. Cl. G06F 3/0481; G06F 3/0482; G06F 17/30

(52) U.S. Cl. CPC G06F 3/04817; G06F 17/30988; G06F 3/0482; G06F 17/30061
USPC 715/815; 707/736; 715/825

(57) ABSTRACT

A system for dynamically visualizing POI (Point Of Interest) attribute information includes a POI attribute database unit that stores POIs and attribute information of the POIs; and a POI condition searching unit configured to search the POI attribute database unit for attribute information of POIs depending on several conditions to produce the searched POIs. Further, the system includes a service providing unit configured to perform a services such as a web map service or a navigation service using the searched POIs provided from the POI condition searching unit; and a display unit configured to display results of the service.

### CROSS-REFERENCE TO RELATED APPLICATION(S)

The present invention claims priority of Korean Patent Application No. 10-2013-0106101, filed on Sep. 4, 2013, which is incorporated herein by reference.

### FIELD OF THE INVENTION

The present invention relates to a system and method for dynamically establishing and maintaining POI (Point Of Interest) attribute information being utilized in a web map and navigation services and dynamically visualizing status information of POI in accordance with a value of POI attribute information.

### BACKGROUND OF THE INVENTION

POI (Point Of Interest) is widely utilized to search for shops or specific positions in a web map or to locate or display destinations in a navigation service. For instance, an example of POI may be information such as “KOEX” which is a representative Convention Center in Seoul, Korea and a “JFK airport” which is one of representative American airports. The POI has presence location information as its attribute information and is visualized at a designated location by using an icon in a web map service or navigation service.

The POI may have additional attributes representative of types and features of geographic information and geographical object that the POI means or points out along with location information (e.g., latitude and longitude coordinates, etc.) of a place where the POI is situated. For example, in the case of POI being shops, restaurants, hospitals, and others, the POI may have additional features such as business hours of the POIs, available user types (youth, adult, etc.).

Further, additional attribute information of the POIs may contribute to provide more accuracy and details in the web map and navigation services. For example, if the user is a youth, these services may do not provide to the youth a search for and guidance for pubs and shops to which youth is not available. Also, in case of the business hours of the restaurants, these services may be excluded them from the search objects depending on the search period of POI.

However, if the user separately inquiries or requests several attribute information of POI by taking further actions, the present map and navigation services still perform a search and provide a search result to the user. For example, the present map and navigation services have been made in a way to represent the location of the POI in the form of an icon and to express attribute information relevant to the POI through a separate window or a separate area, or a new popup window if there is another request from the user such as the selection of an additional button.

In particular, if a mobile terminal has a small-sized screen enough not to display information such as the web map and navigation, it is essentially required to enter additional information by the user.

### SUMMARY OF THE INVENTION

In view of the above, the embodiment of the present invention is intended to solve the problems as described above, the present invention provides an apparatus and method for dynamically visualizing attribute information of POI in order to provide different attribute information of POI (e.g., such as available hours of the POI, available user type, etc.) without additional user input. This enables the user to effectively provide with the different attribute information of the POI in diverse manners.

The object of the present invention is not limited to that described above and other objects that are not described above will be apparently understood by those skilled in the art from the following description.

In accordance with a first aspect of the present invention, there is provided a system for dynamically visualizing POI (Point Of Interest) attribute information. The system includes a POI attribute database unit that stores POIs and attribute information of the POIs; a POI condition searching unit configured to search the POI attribute database unit for attribute information of POIs depending on several conditions to produce the searched POIs; a service providing unit configured to perform a services such as a web map service or a navigation service using the searched POIs provided from the POI condition searching unit; and a display unit configured to display results of the service.

Further, the system may further comprise a server that centrally manages functions of the POI condition searching unit and the service providing unit.

Further, the POI attribute information may comprise a name, address, and representative location of the POI, whether a service is available, user type, or an attribute of external reference.

Further, the attribute of external reference may represent an ID of a relevant POI as DDDDD when a portion of an attribute value of the POI is determined by a portion of an attribute value of another POI.

Further, the dynamic visualization of the POI may be employed in searching a particular POI on a web map or in guiding a path in the navigation. Further, information about whether the service is available may be represented by adding an additional symbol to a preset portion in the icon.

Further, the attribute information of the POI may be dynamically selected in accordance with a situation where the user is served or information about the user.

In accordance with a second aspect of the present invention, there is provided a method for dynamically visualizing POI (Point Of Interest) attribute information. The method includes searching POI to be displayed based on a current location of a user terminal which is being served or a search location inputted by the user; selecting an icon in accordance with attribute information of the searched POI, the icon being associated with the selected POI and is used to visualize the searched POI; visualizing the selected icon to provide the attribute information of the POI based on POI attribute information to the user and visualizing information on whether or not the service is available.

Further, the POI attribute information may comprise a name, address, and representative location of the POI, whether the service is available, user type, or an attribute of external reference.

Further, the attribute of external reference represents an ID of a relevant POI as DDDDD when a portion of an attribute value of the POI may be determined by a portion of an attribute value of another POI.

Further, the visualizing information on whether or not the service is available using the icon may comprise causing the icon to be dark; causing the icon to be blurred; adding a separate symbol or figure to a portion of the icon; or adjusting the size of the icon.

Further, the dynamic visualization of the POI may be employed in searching a particular POI in a web map or in guiding a path in the navigation.

Further, information about whether the service may be available is represented by adding an additional symbol to a preset portion in the icon.

Further, the attribute information of the POI may be dynamically selected in accordance with a situation where the user is served or information about the user.

In accordance with a third aspect of the present invention, there is provided a method for dynamically visualizing POI (Point Of Interest) attribute information performed in a POI attribute information visualization system, the system including POI and a service server. The method includes receiving attribute information value of POI that is refreshed from the service server that provides a service related to the dynamic change in the POI attribute information when POI attribute information of POI is dynamically changed; selecting an icon in accordance with the refreshed attribute information value of the POI, the icon being associated with the POI and is used to visualize the POI; and visualizing the selected icon to provide information on the attribute information value of the POI that is dynamically changed.

Further, the POI attribute information may comprise a name, address and representative location of the POI, whether the service is available, user type, or an attribute of external reference.

Further, the attribute of external reference represents an ID of a relevant POI as DDDDD when a portion of the attribute information value of POI may be determined by a portion of the attribute information value of another POI.

In accordance with an embodiment of the present invention, it is possible to establish different attribute information of POI, represent and provide a POI satisfying specific conditions based on the established attribute information or provide and visualize the different attribute information along with the POI in a diverse manner, which results in an efficient provision and visualization of the POI while minimizing the user inputs.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a system for dynamically visualizing POI attribute information in accordance with an embodiment of the present invention;

FIG. 2 is a flow diagram illustrating a method for dynamically visualizing POI attribute information using the system shown in FIG. 1 in accordance with an embodiment of the present invention;

FIG. 3 is a flow diagram illustrating a method for dynamically visualizing (refreshing) attribute information of POI using the POI attribute information system shown in FIG. 1 in accordance with an embodiment of the present invention;

FIGS. 4A to 4H illustrate examples in which the attribute information of the POI is dynamically visualized in accordance with an embodiment of the present invention;

FIGS. 5A to 5D illustrate cases where the examples in FIG. 4A to 4H are employed in a web map service and in a guidance of a path in a navigation service;

FIG. 6 shows an example of attribute information of the POI; and

FIGS. 7A and 7B illustrate examples where the visualized POI changes continuously with the phases of the visualization of the POI.

### DETAILED DESCRIPTION OF THE EMBODIMENTS

Hereinafter, exemplary embodiments of the present invention will be described in detail with reference to the accompanying drawings. Detailed descriptions of well-known functions and structures incorporated herein may be omitted to avoid obscuring the subject matter of the present invention. The terms used herein are those defined in consideration of the functions of the present invention and may be different according to the intentions and customs of a user or a manager. Therefore, the definitions of the terms will be fixed on the basis of the entire content of the specification.

Hereinafter, the operation of the respective components of a system for dynamically visualizing POI attribute information in accordance with an embodiment of the present invention will be described in detail with reference to the accompanying drawings.

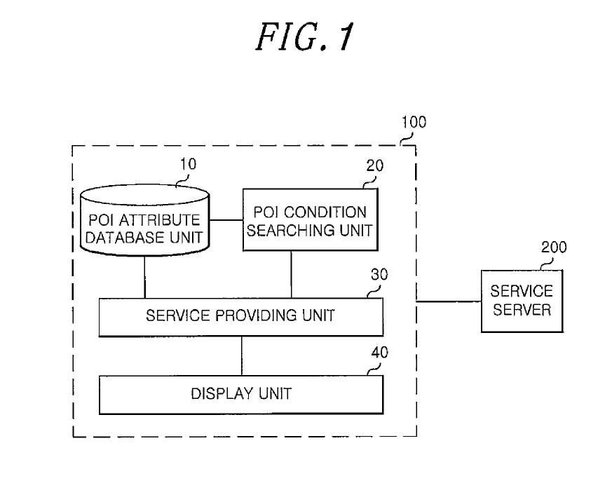

Referring to FIG. 1, a system 100 for dynamically visualizing POI attribute information in accordance with an embodiment of the present invention may include a POI attribute database unit 10, a POI condition searching unit 20, a service providing unit 30, and a display unit 40.

The POI attribute database unit 10 serves to store POIs and attribute information of the POIs, and the POI condition searching unit 20 searches the POI attribute database unit 10 for attribute information of POIs being utilized in services depending on several conditions and provides the searched POIs to the service providing unit 30.

The service providing unit 30 performs service such as a web map service and a navigation service in practice using the POIs provided from the POI condition searching unit 20. The display unit 40 displays the results of the service.

The POI attribute information visualization system 100 having the aforementioned components may be installed in a user system that is capable of providing the services, such as a mobile terminal or a personal computer (PC).

It may be possible to modify the configuration of the POI attribute information visualization system 100 such that a service server 200 is responsible for centrally providing the functions performed by the POI attribute database unit 10 and the POI condition searching unit 20. In this case, the service providing unit 30 is adapted to transfer the conditions to be searched to the server 200 and the search result from the server 200 is displayed for visualization thereof on the display unit 40.

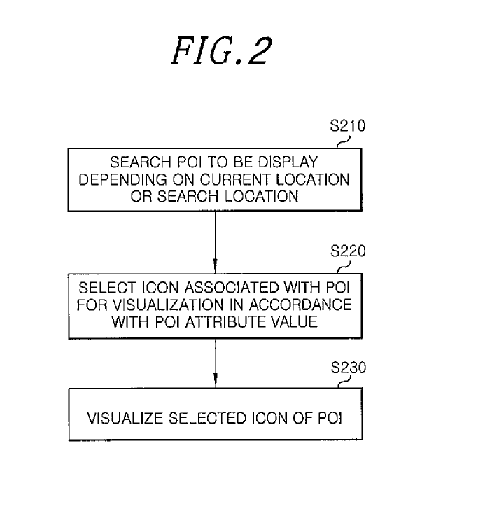

FIG. 2 is a flow diagram illustrating a method for dynamically visualizing POI attribute information using the POI attribute information visualization system 100 in accordance with an embodiment of the present invention.

Hereinafter, the method for dynamically visualizing POI attribute information using the POI attribute information visualization system 100 will be described with reference to FIG. 2.

When a POI-based service such as a web map or navigation is performed for the user, in order to visualize the POI in the form of an icon or the like during using the service, a POI to be displayed is firstly searched based on a current location of the user terminal or a search location where the user wishes to visit (S210).

Next, an icon is selected depending on attribute information of the searched POI (S220), the icon being associated with the POI and is used to visualize the POI. For example, different icons may be selected depending on whether the service is available to the user. As an example, an icon that is commonly representative of the POI may be selected in case where the current time when the user wants to use the service is in a business hour of the searched POI, whereas an icon including numbers and/or symbols meaning that the searched POI is not available to the user in case where the business hour of the searched POI has passed already (e.g., an icon in the form of a coffee cup having a cross mark (X) on a upper right as illustrated in a reference numeral 5210 of FIG. 2).

The attribute information of the searched POI may be effectively provided to the user based on different attribute information by visualizing the selected icon through a screen of the display unit (S230).

The POIs and attribute information of the POIs as described above may be stored in advance in the user terminal that is capable of providing the web map and navigation services or may be provided from the server when performing the services in accordance with the design and implementation schemes the services. Meanwhile, a portion of attribute information of the searched POI may be changed in its log value in real time. In this case, the visualized icon associated with the searched POI may be refreshed in real time based on the value of the POI attribute information provided from the server, which leads to a dynamic visualization of POI attribute information that are dynamically changed.

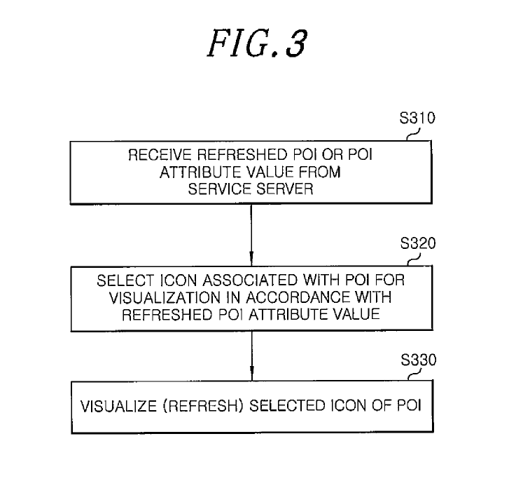

Hereinafter, a method for dynamically visualizing (refreshing) POI attribute information based on the dynamic change in the POI attribute information will be described with reference to FIG. 3.

Referring to FIG. 3, in case where POI attribute information (e.g., a closing hour of a shop, etc.) is changed dynamically, the user terminal receives in real time POI attribute information that is refreshed from a service server that provides a relevant service through a variety of communication methods (S310).

Next, the user terminal selects again the icon that is associated with the POI and is used to visualize the POI in accordance with the refreshed value of the POI attribute information POI (S320). For example, when there occurs a situation that a restaurant closes ahead of the closing hour for a certain reason, the user terminal may receive information on the closing of the restaurant from the service server and select an icon reflecting information on the new refreshed closing hour of the restaurant.

The information about the POI attribute information with the dynamic change may be effectively provided to the user by visualizing the selected icon through a screen of the display unit (S330).

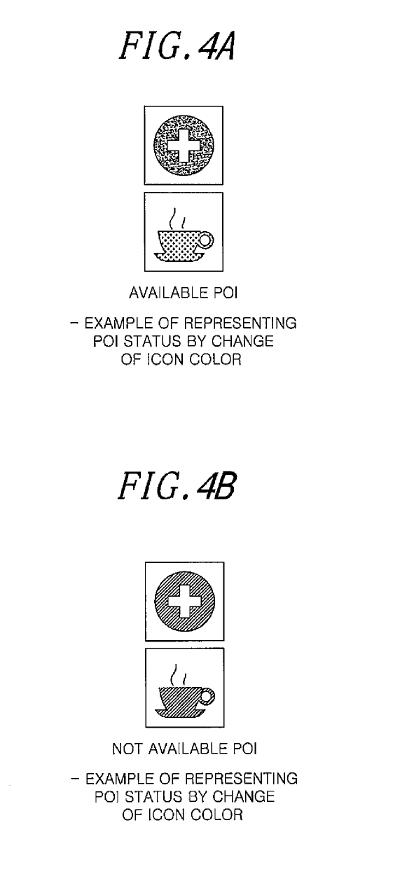

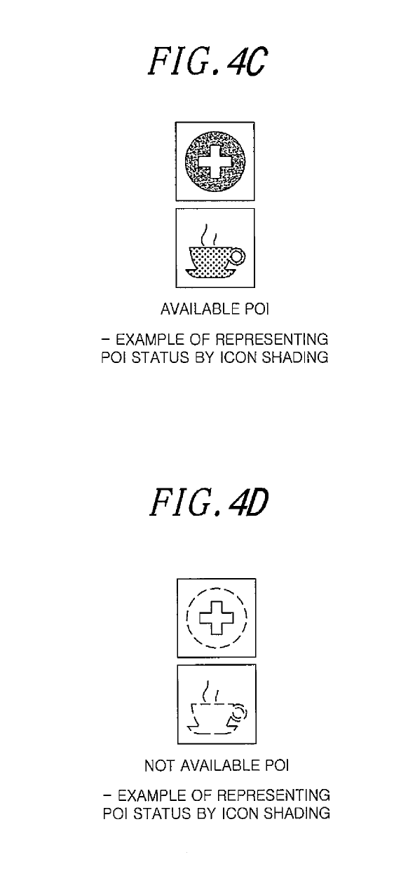

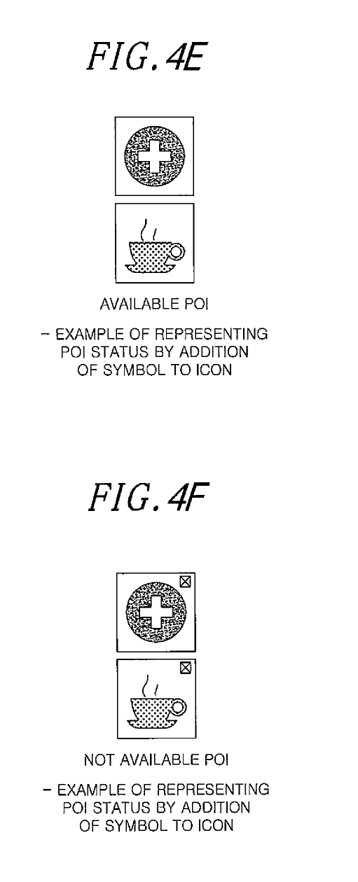

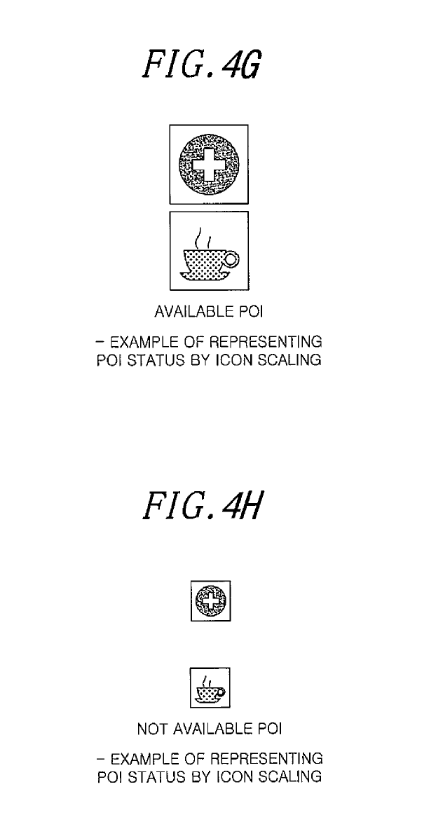

FIGS. 4A to 4H illustrate examples in which the POI attribute information is dynamically visualized in accordance with an embodiment of the present invention.

Referring to FIG. 4A to 4H, there are shown POI attribute information of POIs such as business hours a hospital and coffee shop among other things (in other words, POI attribute information about whether or not the POIs are open for business) wherein the icons representative of the POIs demonstrate that the POIs are not available.

More specifically, FIGS. 4A and 4B illustrate how to explain that the hospital and the coffee shop are available by making the icon dark. In addition, FIGS. 4C and 4D illustrate to make the icon blur; FIGS. 4E and 4F illustrate to add a separate symbol or figure to a portion of the icon; and FIGS. 4G and 4H illustrate to scale or adjust the size of the icon.

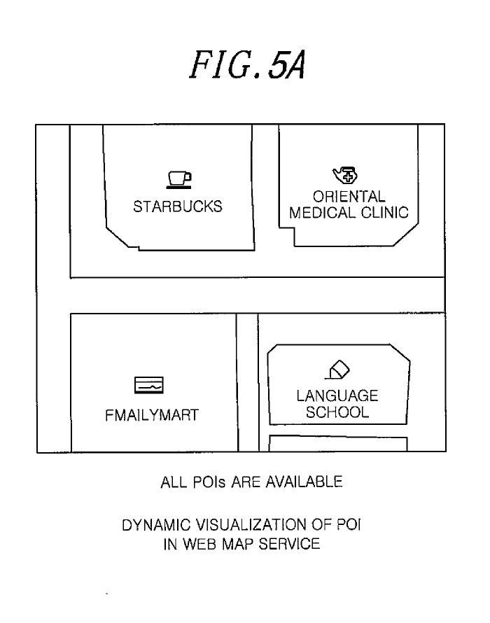

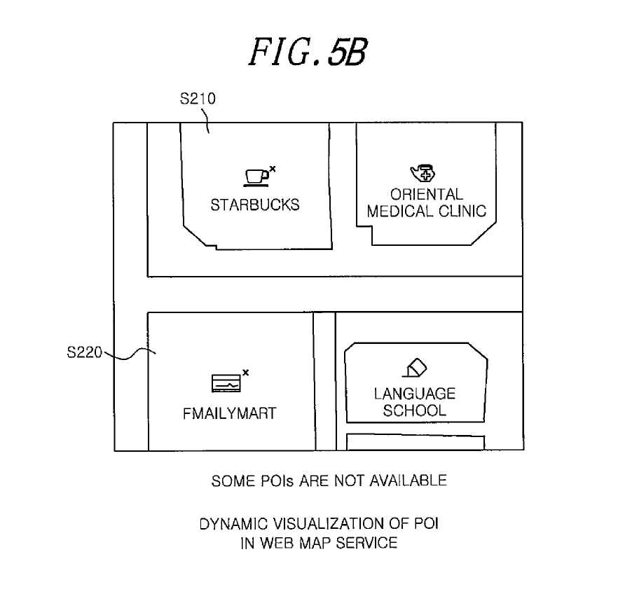

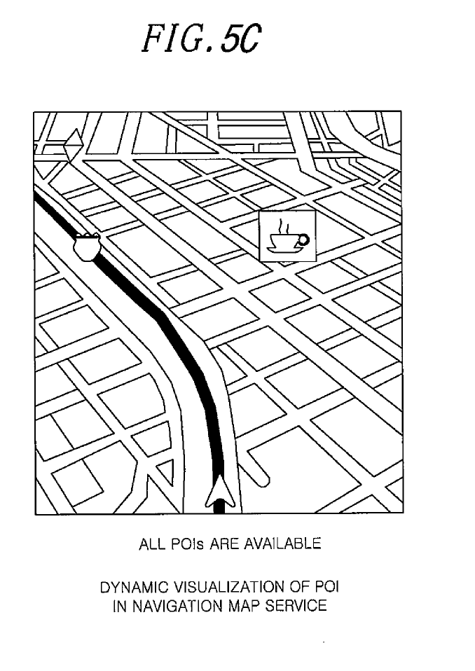

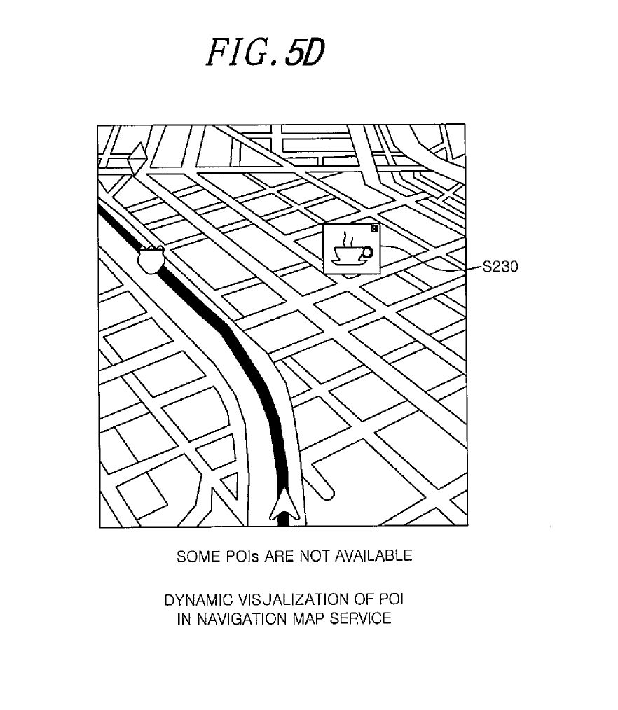

FIG. 5A to 5B illustrate a case where the examples in FIG. 4A to 4H are employed in searching a specific point in a web map service and FIGS. 5C and 5D illustrate a case where the examples in FIGS. 4A to 4H are employed in guiding a path in a navigation service.

To put them another way, FIG. 5A illustrates a case where all POIs in the web map are available. However, when some of the POIs in the web map are not available, for example, when two POIs such as the STARBUCKS and the FAMILY MART at the left upper end and left lower end, respectively, close their business, FIG. 5B represents a situation where the POIs are not available at current while they exist in their relevant area by providing icons in which an additional symbol such as an X mark is added to a right upper end of the icons associated with the POIs.

FIG. 5C illustrates a case where all POIs in the navigation map are available. However, when some of the POIs in the navigation map are not available, FIG. 5D informs that the coffee shop is not available by providing an icon in which an additional symbol such as an X mark is added to the icon associated with the coffee shop around the POI searched during the navigation.

The POI attribute information (e.g., business hour and available user type, etc.) may be dynamically selected and visualized in accordance with a situation where the user is served (e.g., a service time) and age/sex (youth, man, woman, etc.).

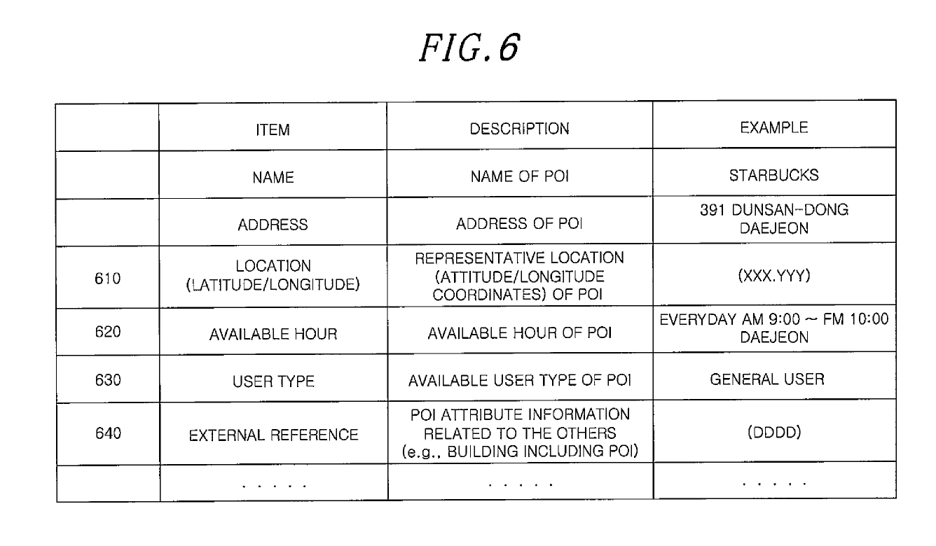

FIG. 6 shows a representative example of the POI attribute information, wherein the poi attribute information may exist in various types in accordance with geometric information pointed out by the POIs and kinds and features of geographical information objects.

In FIG. 6, among other attribute information, location (latitude and longitude) information 610 represents the geographic location of a relevant POI as (XXX, YYY), information on available time 620 indicates business hour of a relevant POI, and information on a user type 630 indicates whether the POI is available to the user.

In addition, attribute to external reference 640 is used to reference collateral circumstances by representing the ID of the POI as ‘DDDDD’ when a portion of an attribute value of a relevant POI is determined by a portion of attribute values of another POI, for example, when a business hour of a relevant POI is determined by a business hour of a building which rents to the relevant POI.

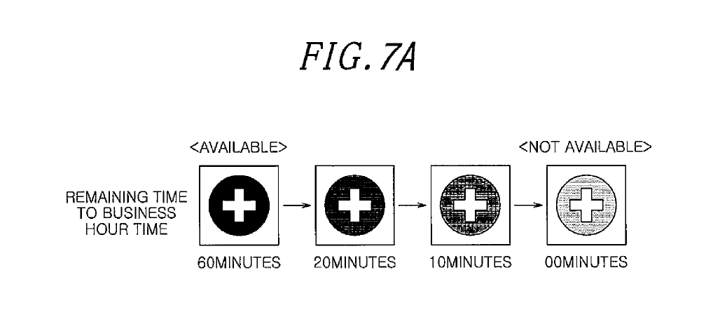

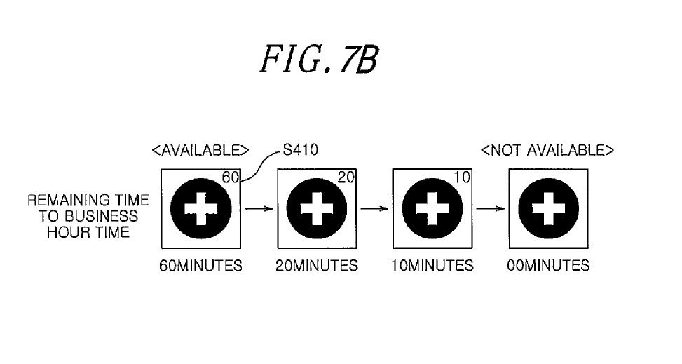

FIGS. 7A and 7B illustrate examples where the visualized POI changes continuously with the phases of the visualization of the POI.

FIG. 7A illustrates that an icon representing a hospital becomes blurred gradually in proportion to a remaining time up to the business hour time, and FIG. 7B illustrates that a remaining time up to a business hour is displayed visually on an icon representing a hospital. Accordingly, the system of the embodiment enables to provide information about situations with dynamic change to the user.

The combinations of the each block of the block diagram and each step of the flow chart may be performed by computer program instructions. Because the computer program instructions may be loaded in a general purpose computer, a special purpose computer, or other processor of programmable data processing equipment, the instructions performed through the computer or other processor of programmable data processing equipment may generate the means performing functions described in the each block of the block diagram and each step of the flow chart. Because the computer program instructions may be stored in the computer available memory or computer readable memory which is capable of intending to a computer or other programmable data processing equipment in order to embody a function in a specific way, the instructions stored in the computer available memory or computer readable may produce a manufacture item involving the instruction means performing functions described in the each block of the block diagram and each step of the flow chart. Because the computer program instructions may be loaded on the computer or other programmable data processing equipment, the instructions performing the computer or programmable data processing equipment may provide the steps to execute the functions described in the each block of the block diagram and each step of the flow chart by a series of operation steps being performed on the computer or programmable data processing equipment, thereby a process executed by a computer being generated.

Further, each block or each step may represent a module, a segment, or a portion of the code which is including one or more executable instructions for executing specified logical function(s). Further, in several alternative embodiments, it is necessary to note that the functions mentioned in blocks or steps may occur out of order. For example, two blocks or steps shown in series may be practically performed simultaneously, or may be performed in reverse order according to functions.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A system for dynamically visualizing POI (Point Of Interest) attribute information, the system comprising:
a POI attribute database unit that stores POIs and attribute information of the POIs;
a POI condition searching unit configured to search the POI attribute database unit for attribute information of POIs depending on several conditions to produce the searched POIs;
a service providing unit configured to perform a services such as a web map service or a navigation service using the searched POIs provided from the POI condition searching unit; and
a display unit configured to display results of the service.

2. The system of claim 1, further comprising a server that centrally manages functions of the POI condition searching unit and the service providing unit.

3. The system of claim 1, wherein the POI attribute information comprises a name, address, and representative location of the POI, whether a service is available, user type, or an attribute of external reference.

4. The system of claim 3, wherein the attribute of external reference represents an ID of a relevant POI as DDDDD when a portion of an attribute value of the POI is determined by a portion of an attribute value of another POI.

5. The system of claim 1, wherein the dynamic visualization of the POI is employed in searching a particular POI on a web map or in guiding a path in the navigation.

6. The system of claim 5, wherein information about whether the service is available is represented by adding an additional symbol to a preset portion in the icon.

7. The system of claim 1, wherein the attribute information of the POI is dynamically selected in accordance with a situation where the user is served or information about the user.

8. A method for dynamically visualizing POI (Point Of Interest) attribute information, the method comprising:
searching POI to be displayed based on a current location of a user terminal which is being served or a search location inputted by the user;
selecting an icon in accordance with attribute information of the searched POI, the icon being associated with the selected POI and is used to visualize the searched POI;
visualizing the selected icon to provide the attribute information of the POI based on POI attribute information to the user and visualizing information on whether or not the service is available.

9. The method of claim 8, wherein the POI attribute information comprises a name, address, and representative location of the POI, whether the service is available, user type, or an attribute of external reference.

10. The method of claim 9, wherein the attribute of external reference represents an ID of a relevant POI as DDDDD when a portion of an attribute value of the POI is determined by a portion of an attribute value of another POI.

11. The method of claim 9, wherein said visualizing information on whether or not the service is available using the icon comprises:
causing the icon to be dark;
causing the icon to be blurred;
adding a separate symbol or figure to a portion of the icon; and
adjusting the size of the icon.

12. The method of claim 8, wherein the dynamic visualization of the POI is employed in searching a particular POI in a web map or in guiding a path in the navigation.

13. The method of claim 12, wherein information about whether the service is available is represented by adding an additional symbol to a preset portion in the icon.

14. The method of claim 14 wherein the attribute information of the POI is dynamically selected in accordance with a situation where the user is served or information about the user.

15. A method for dynamically visualizing POI (Point Of Interest) attribute information performed in a POI attribute information visualization system, the system including POI and a service server, the method comprising:
receiving attribute information value of POI that is refreshed from the service server that provides a service related to the dynamic change in the POI attribute information when POI attribute information of POI is dynamically changed;
selecting an icon in accordance with the refreshed attribute information value of the POI, the icon being associated with the POI and is used to visualize the POI; and
visualizing the selected icon to provide information on the attribute information value of the POI that is dynamically changed.

16. The method of claim 15, wherein the POI attribute information comprises a name, address and representative location of the POI, whether the service is available, user type, or an attribute of external reference.

17. The method of claim 16, wherein the attribute of external reference represents an ID of a relevant POI as DDDDD when a portion of the attribute information value of POI is determined by a portion of the attribute information value of another POI.
